(19) United States
(12) Patent Application Publication
(10) Pub. No.: US 2004/0238092 A1
(43) Pub. Date: Dec. 2, 2004

(54) TYRE, AND METHOD FOR INCREASING TRACTION OF THE TYRE

(76) Inventors: Gianfranco Colombo, Concorezzo (IT); Andrea Vegro, Uboldo (IT)

Correspondence Address: Finnegan Henderson Farabow, Garrett & Dunner, 1300 I Street N W, Washington, DC, 20005, US

(21) Appl. No.: 10/485,485

(22) PCT Filed: Jul. 29, 2002
(86) PCT No.: PCT/EP02/08411

Related U.S. Application Data
(60) Provisional application No. 60/324,275, filed on Sep. 25, 2001.

(30) Foreign Application Priority Data
Aug. 3, 2001 (EP) 01830526.8

(51) Int. Cl. B60C 11/12; B60C 11/13

(52) U.S. Cl. 152/209.15; 152/209.25

(57) ABSTRACT

A tyre includes a tread including a relief pattern delimited by a plurality of circumferential and transverse grooves forming at least one circumferential row of blocks projecting from a base surface of the tread and extending radially outward as far as top surfaces of the blocks. Each block is delimited by longitudinal and transverse lateral surfaces. Each lateral surface is part of at least one wall of the grooves. At least one block includes at least one notch in one or more of its surfaces. At least one side of the at least one notch is open along an entire length of one of the surfaces. The at least one notch includes a greater dimension oriented in a direction of one of the grooves and is tapered along that dimension between a base and a vertex opposite the base. A method for increasing traction of the tyre is also disclosed.

The present invention relates to tyres for motor vehicles, particularly for use on snow-covered ground.

A tyre in its most general form comprises a casing structure, including a central crown portion and two axially opposed sidewalls terminating in a pair of beads for fixing to the rim of a wheel, and a tread extending coaxially around the crown portion. In radial casing tyres there is also a belt structure associated coaxially with the casing structure.

In turn, the tread comprises a relief pattern formed by a plurality of circumferential and transverse grooves which, in combination, give rise to a plurality of blocks distributed according to different types of configuration, for example along a central area extending across the equatorial plane and in at least two shoulder areas, extending on axially opposite sides of the central area.

The configuration of the blocks can vary, but generally each of them projects from the base surface of the tread to terminate in a top surface.

Each block is generally delimited by a pair of longitudinal lateral surfaces and a pair of transverse lateral surfaces, the first of these being directed parallel to the equatorial plane or with a slight inclination with respect to it, while the second surfaces intersect the first in a generally axial direction and in any case with a large angle of inclination with respect to the equatorial plane.

The longitudinal and transverse lateral surfaces of the blocks are also the walls delimiting the aforesaid grooves: the base surfaces of the said grooves coincide with the said base surface of the tread.

Of particular importance for a tyre for snow-covered ground is the presence in the blocks of suitable sipes, in other words a dense series of slots or very narrow grooves, orientated essentially transversely to the direction of rolling, the function of the sipes being essentially to collect and efficiently retain the snow, since the friction of snow on snow is well known to be greater than the friction of snow on rubber.

For example, U.S. Pat. No. 5,711,828 describes a tyre for snow-covered ground provided with a tread pattern formed by a plurality of blocks, each grooved with a plurality of zigzag sipes which are all parallel to each other.

The document EP 0,713,790 A2 describes a winter tyre designed to improve performance on snow by maintaining good characteristics of resistance to the known phenomenon of aquaplaning.

This tyre comprises three circumferential grooves intersected by a plurality of transverse grooves forming in combination two circumferential rows of central blocks at the sides of the equatorial plane and two circumferential rows of shoulder blocks.

The central blocks are in the shape of parallelograms having longitudinal sides inclined at an angle of 3° to 15° to the equatorial plane. Each block is provided with a plurality of zigzag sipes running transversely to the block and parallel to each other.

Some sipes have notches, with a width and depth of approximately 1 mm, at their ends.

Each of these notches has walls delimited by the elastomeric material of the block and opens into a longitudinal groove.

U.S. Pat. No. 4,815,511 relates to a tyre of the all-seasons type, made to improve the traction characteristics on snow-covered ground.

The tyre comprises four circumferential grooves and a plurality of transverse grooves forming, in combination, three circumferential rows of blocks, namely one central and two lateral rows, and two rows of shoulder blocks.

Each row comprises a first and a second set of triangular blocks alternating with each other circumferentially.

The blocks of one set have sides forming the walls of a first circumferential groove and vertices opposite these sides located on the walls delimiting a second groove, while the blocks of the other set have vertices aligned with the sides of the first set and opposing sides between the vertices of the first set.

Each block of each row has, in a central position on each longitudinal side, a semicircular notch of small size, open towards the circumferential groove.

Each notch is associated with a narrow sipe running transversely to the block over a short distance.

The tyre is described as an improvement to a prior art tyre in which each block is in the shape of a parallelogram and comprises a pair of notches of trapezoidal shape, extending transversely towards the inside of the block.

These notches open into the circumferential grooves, and are staggered circumferentially with respect to each other in each block, thus forming an essentially S-shaped block.

Additionally, U.S. Pat. No. 6,003,574 held by the present applicant discloses a tyre for snow-covered ground, provided with a tread in which the circumferential grooves are delimited by a sequence of portions which are orientated obliquely with respect to the direction of circumferential extension of the tyre; these oblique portions converge symmetrically towards the equatorial plane, but in a direction opposite to the direction of convergence of the transverse grooves.

Each of the oblique portions of the circumferential grooves extends between two consecutive transverse grooves and delimits opposing circumferential edges of a centre block and a shoulder block.

In this solution, each of the centre and shoulder blocks has a corner projecting into the corresponding circumferential groove, with respect to the adjacent corner of the immediately following block.

In this situation, the projecting corners of the central blocks act as teeth which ensure a grip on the snow in traction, while the projecting corners of the shoulder blocks produce this effect during braking.

In order to increase the grip on snow, the tyre also has a notch of trapezoidal shape extending into every two adjacent blocks in each centre row

This notch passes through the transverse groove between the two centre blocks and has an axially inner circumferential edge and an axially outer circumferential edge, which diverge from each other, at angles preferably in the range from 3° to 15°, in a direction opposite to the rolling direction.

Having examined the prior art indicated above, the applicant has found that it is possible to improve the roadholding of the tyre on snow-covered ground, by forming special notches, designed to act as traps for the encapsulation of snow, in the blocks, making use of the removal of elastomeric material over a longitudinally extending portion of the lateral surface forming the delimiting wall of a first groove.

It has also been found that the making of such notches extending for a considerable distance in the longitudinal direction and open along the delimiting edge between a lateral surface of the block and the corresponding top surface makes it possible to store a sufficient quantity of snow to improve the grip on the ground.

It has also proved possible to improve the capture of snow by making the notch in a pyramidal shape, preferably with the base surface closed at one end, and terminating at the other end with its vertex lying on the wall delimiting the said first groove.

It has also been found that, by removing the elastomeric material as indicated above, it is possible to form a step in the top surface of the block, thus surprisingly keeping unchanged the resistance of the block to the forces acting against the surface of the block in which this step is cut.

In a first aspect, the invention relates to a tyre comprising a tread provided with a relief pattern delimited by a plurality of circumferential and transverse grooves forming at least one circumferential row of blocks projecting from a base surface of the said tread and extending radially outwards as far as their top surface, at which each block is delimited by longitudinal lateral surfaces and transverse lateral surfaces, each of which is part of at least one wall of the said grooves, while at least one of the said blocks has at least one notch in one of the said surfaces.

According to the invention, the said at least one notch has at least the following characteristics:

a) its greater dimension is orientated in the direction of one of the said circumferential and transverse grooves delimited by the said walls;

b) at least one of its sides is open along its whole length on one of the said surfaces;

c) its shape is tapered along the said greater dimension between a base and a vertex opposite the said base.

Preferably, the said at least one notch is formed along the delimiting edge between the said top surface and the wall delimiting the said groove.

In a preferred embodiment, each of the blocks of at least one circumferential row comprises at least one of these notches.

Preferably, the said base of the notch is generated by a plane intersecting the block at a predetermined distance from the vertex.

In one embodiment, all the notches formed in a surface of the block delimiting the same groove are tapered in the same direction, preferably in the direction opposite the direction of rolling of the tyre.

In an alternative embodiment to the preceding one, these notches are tapered in opposite directions.

Preferably, each block of the said at least one row comprises at least a first and a second longitudinal notch, the first notch being on the delimiting edge between the top surface and a first longitudinal lateral surface, and the second notch being on the delimiting edge between the top surface and a second longitudinal lateral surface.

Even more preferably, the said first and second notches have tapers in opposite directions to each other in each block.

In some embodiments, the tyre can comprise, in at least one block, at least one notch running transversely with respect to the direction of movement, and preferably the said at least one transverse notch is formed along the delimiting edge between the top surface and a transverse lateral surface of the block.

Preferably, the tyre comprises, in each block, a pair of the said notches which are transverse with respect to the direction of movement, each of these notches being formed along the delimiting edge between the top surface and a corresponding transverse lateral surface.

These transverse notches can be formed in blocks in which one or more longitudinal notches are provided.

In a preferred embodiment, the notch, whether longitudinal or transverse, has a pyramidal shape, essentially delimited by a base and by two lateral planes, namely the first and the second plane, which are incident on each other, in the absence of other delimiting planes, since the notch is open on its outer sides; more particularly, the first plane is perpendicular to the top surface of the block and inclined at an angle α to the wall of the groove in which the notch is formed, while the second plane is inclined at an angle β to an incident plane, parallel to the top surface.

Again with reference to preferred embodiments, the notch extends over a length at least equal to 65% of the length of the edge formed by the intersection between the lateral surface of the block in which the notch is formed and the said top surface of the block.

Additionally, the ratio “p/l” between the maximum depth “p” of the notch measured in a direction perpendicular to the top surface of the block (at the base of the notch) and the maximum longitudinal extension “l” of the notch, measured along the corresponding edge on the top surface, is in the range from 0.06 to 0.6.

In a different aspect, the invention relates to a method for increasing the traction of a tyre for vehicle wheels on snow-covered ground, the said tyre comprising a tread provided with a relief pattern formed by a plurality of circumferential and transverse grooves which, in combination, give rise to a plurality of blocks projecting from a base surface of the said tread, extending radially outwards up to their top surfaces and delimited by longitudinal lateral surfaces and transverse lateral surfaces, each of which is part of at least one wall of the said grooves, the said method being characterized in that at least one notch is formed in one of the said surfaces of the said blocks, the said notch having its greater dimension orientated in the direction of one of the said circumferential and transverse grooves delimited by the said walls, at least one side open over its whole length on one of the said surfaces, and a shape which is tapered along the said greater dimension between a base and a vertex opposite the said base.

Further characteristics and advantages will be made clearer by the following description of a preferred example of embodiment of a tyre according to the invention, provided for information and without restrictive intent with reference to the attached drawings, in which:

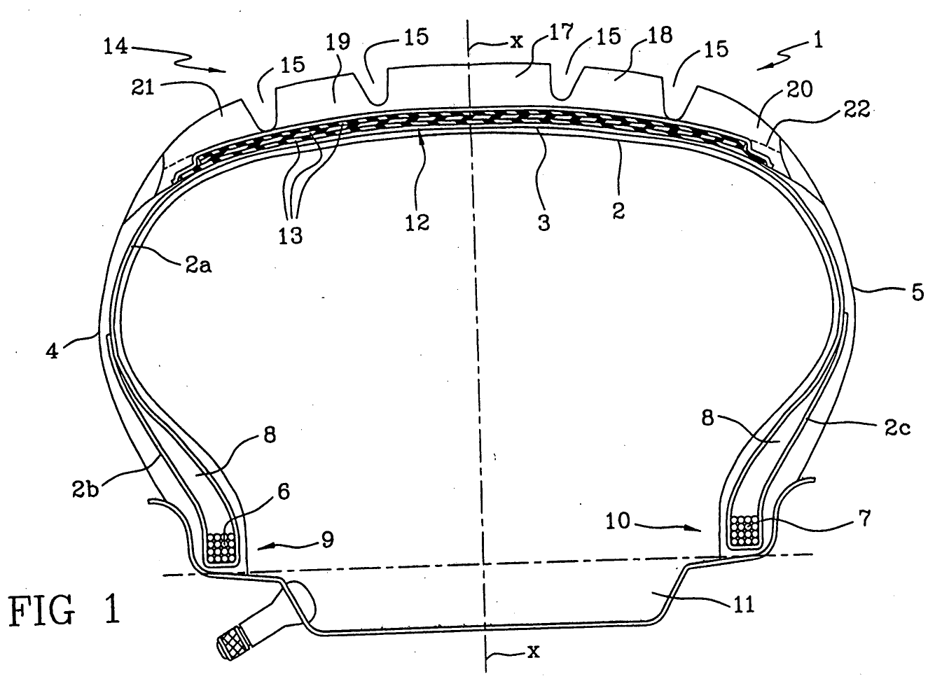

FIG. 1 shows a cross-sectional view of a tyre according to the invention;

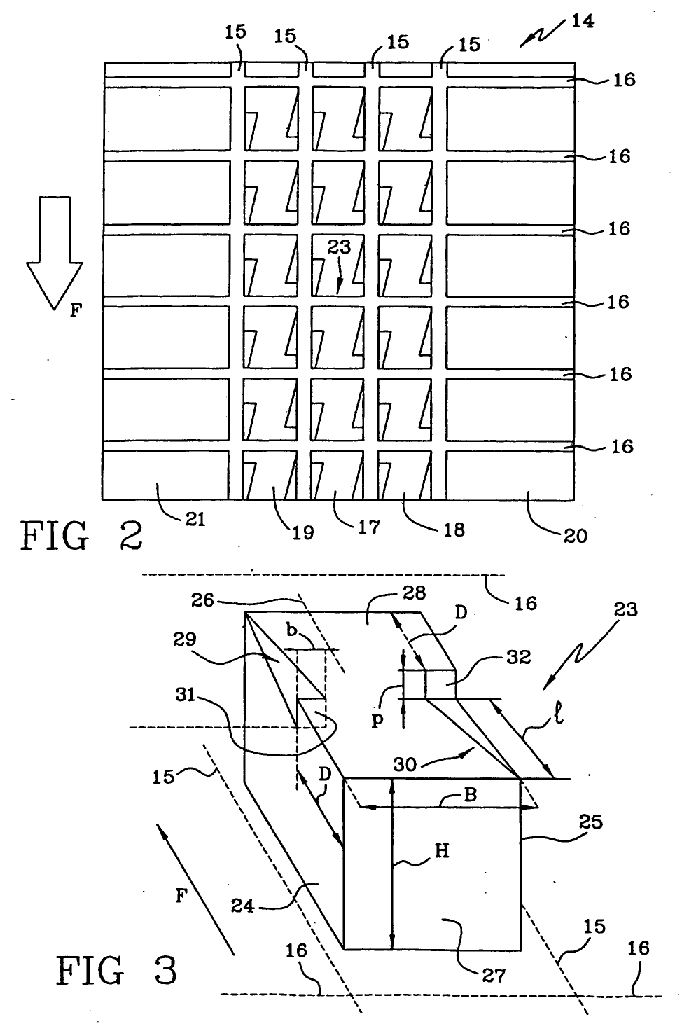

FIG. 2 shows a schematic partial development in plan view of the tread of the tyre of FIG. 1;

FIG. 3 shows an enlargement of a block of the tread of FIG. 2;

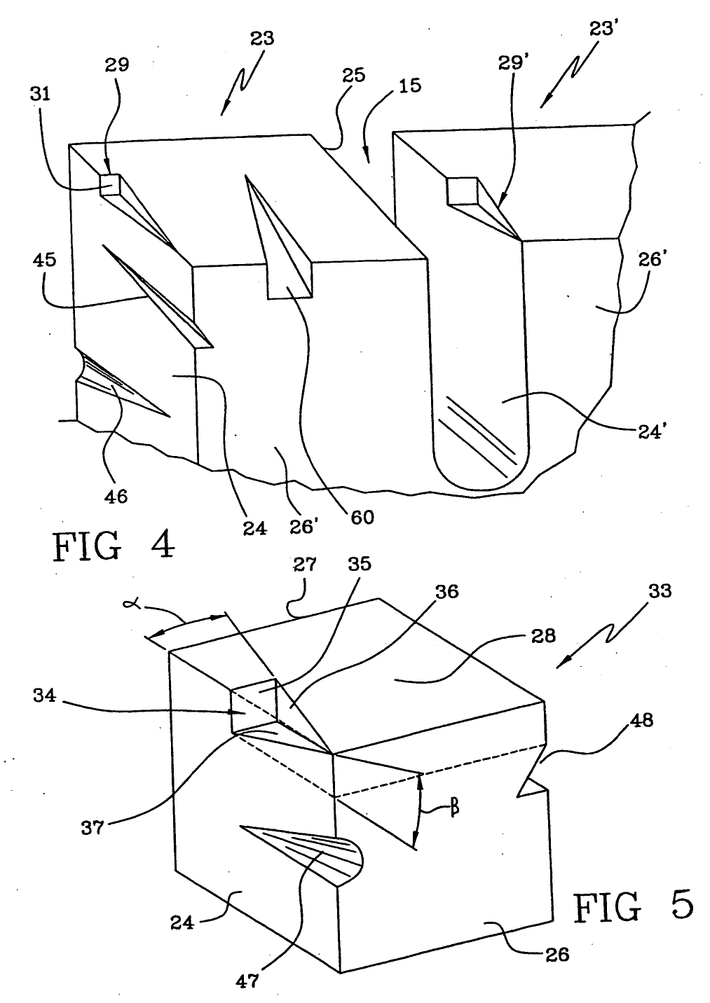

FIG. 4 shows a variant of some characteristics of the block of FIG. 3;

FIG. 5 shows an enlargement of some characteristics of the block of FIG. 3 and some variant embodiments of the said characteristics;

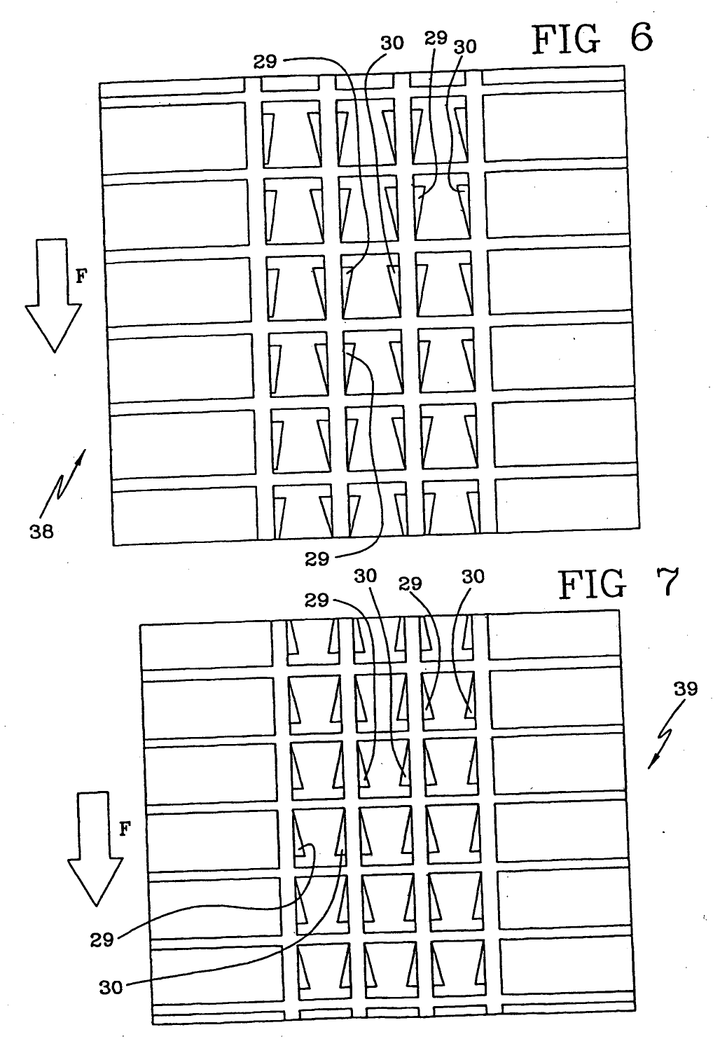

FIG. 6 shows in plan view a schematic pattern for a tread which is an alternative to that of FIG. 2, orientated in a predetermined direction of rolling of the tyre;

FIG. 7 shows the pattern of FIG. 6 orientated in the opposite direction with respect to the said direction of rolling of the tyre;

FIG. 8 shows another variant embodiment of a block according to the invention;

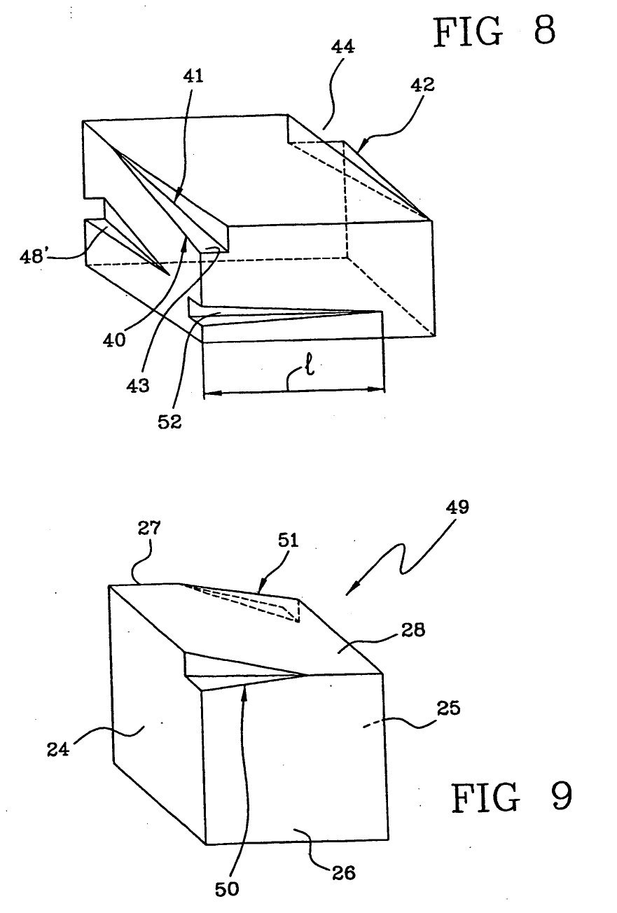

FIG. 9 shows a further example of embodiment of a block according to the invention;

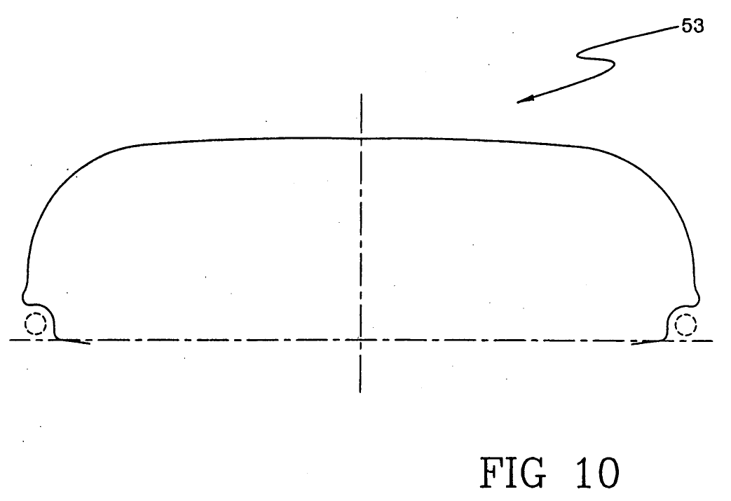

FIG. 10 shows the mid-line profile of a low-profile tyre to which the tread pattern according to the invention can be applied.

With reference to FIG. 1, the number 1 indicates as a whole a tyre for motor vehicles according to the invention, for example a tyre of the 195/65 R15 grade. The tyre 1 comprises a casing structure 2, including a central crown portion 3 and two axially opposed sidewalls 4 and 5, the said casing structure 2 being provided with a reinforcing ply 2a whose opposite ends 2b and 2c are turned up around corresponding bead wires 6 and 7.

In the aforesaid tyre, of the radial type, the cords of the said reinforcing ply lie in radial planes, in other words planes containing the axis of rotation of the said tyre, or in planes having a small inclination with respect to the said radial planes.

On the radially outer perimetric edge of the bead wires 6 and 7, located on the radially inner edges of the said sidewalls 4 and 5, there is applied an elastomeric filler 8 which occupies the space formed between the reinforcing ply 2a and the corresponding ends 2b and 2c of the reinforcing ply 2a.

The axially opposing areas of the tyre 1, each comprising a bead wire 6 or 7 and its filler 8, form what are called the beads, indicated as a whole by 9 and 10, which are designed to secure the tyre 1 on a corresponding mounting rim 11 of the wheel of a vehicle.

In the illustrated example, a belt structure 12, comprising one or more reinforcing strips 13 made from textile or metal cords incorporated in a given mixture, is coaxially associated with the aforesaid casing structure 2.

A tread 14 is applied in a known way to the belt structure 12; a relief pattern, illustrated only schematically in plan view in FIG. 2, is cut in the thickness of the tread.

A tread with the said pattern is particularly suitable for running on snow-covered surfaces.

The tread 14 comprises four circumferential grooves 15 and a plurality of transverse grooves 16, which in combination delimit five rows of blocks having a square shape in plan view, namely a centre row 17 along the equatorial plane, two intermediate rows 18 and 19 at the sides of the central row, and two shoulder rows 20 and 21.

The blocks project from the base surface 22 of the tread, which coincides, in the illustration in FIG. 1, with the layer of mixture positioned directly above the radially outermost reinforcing strip 13 in the belt structure 12, essentially at the base of the grooves.

More particularly, the blocks extend radially outwards up to their top surfaces, which coincide with the outer surface of the tread.

In the example illustrated in FIG. 2, the tread is represented for simplicity with circumferential and transverse grooves running parallel and perpendicular to the equatorial plane respectively, but, as the following text will make clear, the invention is not limited to this particular representation, and includes, for example, circumferential grooves inclined at an angle in the range from 3° to 18° to the equatorial plane, zigzag circumferential grooves, transverse grooves with mid-lines inclined in a non-axial way with respect to the equatorial plane, transverse grooves with curvilinear mid-lines having a convex or concave configuration, or a combined configuration, in other words initially convex and subsequently concave or vice versa in the direction from a shoulder towards the equatorial plane, or again, for example, with a sinusoidal profile or the like in the transverse direction with respect to the tyre between the two shoulders, or in any case circumferential and/or transverse grooves orientated in such a way as to form any type of pattern, which may be symmetrical, asymmetrical or directional.

Preferably, the circumferential grooves have a width in the range from 3 to 18 mm and a depth in the range from 2 to 12 mm.

The transverse grooves have a width in the range from 1.5 to 9 mm and a depth in the range from 2 to 12 mm.

The blocks can have different shapes in plan view from that shown in FIG. 2, and in general can have shapes in plan view in the form of rectangles, parallelograms, polygons or other geometrical figures or any shapes in which it is possible to identify at least one pair of transverse sides in a block, these sides being defined as front and rear according to the direction of rolling of the tyre.

These blocks project from the base surface in the form of parallelepipeds or other forms commonly used in commercially available tyres.

FIG. 3 shows the shape of a block 23, for example a block of the central row 17 of the tread of FIGS. 1 and 2.

The block 17 has the configuration of a parallelepiped delimited by two longitudinal lateral surfaces 24 and 25, two transverse lateral surfaces 26 and 27 which are, respectively, the front and rear surfaces with respect to the direction of travel of the tyre, and a top surface 28.

In FIG. 2, the direction of travel of the tyre is indicated by the arrow “F”.

It should be noted that the longitudinal and transverse lateral surfaces of the block, together with the corresponding surfaces of the blocks of the adjacent rows, form the walls delimiting the longitudinal and transverse grooves.

In FIG. 3, for simplicity, the longitudinal and transverse grooves have been identified by their mid-lines which are shown in broken lines.

As can be seen, the block 23 of FIG. 3 has longitudinal lateral surfaces 24 and 25 forming the axially inner walls of the two circumferential grooves 15 delimiting the centre row 17 and transverse lateral surfaces 26 and 27, each forming one of the two walls of the transverse grooves 16 which are staggered circumferentially with respect to each other.

Moving on to the description of the preferred characteristics of the block 23, it will be noted that this comprises, between the top surface 28 and the longitudinal surfaces 24 and 25, a pair of notches 29 and 30, extending essentially in the circumferential direction, in other words with their greater dimensions orientated in the direction of the groove delimited by the wall in which the notch is formed.

These notches are referred to below as longitudinal notches.

The notches 29 and 30 have their sides open over their whole length both on to the groove delimited by the wall in which they are formed and on to the top surface 28.

These longitudinal notches are formed with profiles tapered in opposite directions to each other.

More particularly, it should be noted that the notch 29 has a direction of taper in the direction of travel F and the notch 30 is tapered in the opposite direction.

Preferably, the two longitudinal notches 29 and 30 are formed with identical dimensions and have identical appearances.

With reference to the illustration of the tread in FIG. 2, it will be noted that all the blocks of all the rows are identical and each is provided with pairs of longitudinal notches with tapers running in opposite directions to each other.

In greater detail, with reference to FIGS. 2 and 3, it will be noted that each longitudinal notch can be formed in the delimiting wall of a groove by removal of elastomeric material or by another process used for manufacturing a tread provided with blocks, for example by moulding.

It should also be noted that the vertex of each longitudinal notch 29 and 30 in the embodiment of FIG. 3 lies on the edge formed by the intersection between the delimiting wall of the longitudinal groove 15 in which the notch is formed and the adjacent wall which delimits the transverse groove 11 in the same block.

In a variant embodiment shown in FIG. 4, the block 23 of the centre row comprises a single longitudinal notch 29 with its vertex separate from the edge formed by the intersection between the longitudinal 24 and transverse 26 surfaces, while the block 23′ of the adjacent intermediate row has a longitudinal notch 29′ with its vertex on the edge formed by the intersection between the lateral and transverse surfaces 24′ and 26′.

Further characteristics of the longitudinal notches 29 and 30 of FIG. 3 relate to their respective bases 31 and 32, formed by a plane intersecting the block perpendicularly to the equatorial plane and located at a predetermined distance “D” from the transverse wall of the block adjacent to the said base.

The distance “D” is measured along the edge forming the intersection between the top surface and the lateral surface of the block, and is equal to the distance between the said base and the edge opposite the vertex of the said notch.

More precisely, the base 31 is located at a distance “D” from the transverse surface 27, corresponding to the wall of the groove 16, opposite the vertex of the notch 29, and the base 32 is located at a distance “D” from the transverse wall 26, opposite the vertex of the notch 30.

Preferably, this distance “D” is not greater than 85% of the length of the edge formed by the intersection between the lateral surface 24 (or 25) in which the notch is formed and the top surface of the same block.

The tapered shape of the notches 29 and 30 has its maximum depth “p”, measured in a direction perpendicular to the top surface of the block (at the bases 31 or 32 of the notches) and zero depth at the vertex.

In the preferred embodiment of FIG. 3, the longitudinal notch has a maximum depth “p” measured on the plane parallel to the equatorial plane passing through the centre of the base and a maximum longitudinal extension “l” measured parallel to the edge formed by the intersection between the top surface 28 and the longitudinal wall 24 or 25 in which the notch is formed.

In this embodiment of the longitudinal notch, the ratio “p/l” is preferably in the range from 0.06 to 0.6.

These values of the ratio “p/l” are preferably associated with a block with a maximum height “H”, measured between the base surface of the tread, from which the block projects, and the top surface.

Preferably, the value “H” is in the range from 2 to 12 mm.

In greater detail, in some preferred embodiments the maximum depth “p” is in the range from 1.5 to 7 mm, and the maximum extension “l” is in the range from 5 to 35 mm.

Preferably also, the ratio “b/B” between the side “b” of the base of the longitudinal notch and the maximum transverse extension “B” (FIG. 3) of the top surface of the block, measured on a plane perpendicular to the equatorial plane, is in the range from 0.0.6 to 0.6.

In practice, both in the embodiment of FIG. 3 and in other embodiments of the invention, the value of the ratio “b/B” expresses as a percentage the extension of the base of the notch into the body of the block relative to the maximum transverse dimension of the said block.

According to the invention, the aforesaid values of the ratios “p/l” and “b/B” and the value “H” are common to other preferred embodiments in which there are blocks having different shapes from that shown in FIG. 3, but in all cases having shapes that can be delimited between at least two longitudinal surfaces and at least two transverse surfaces.

Preferably, the said longitudinal surfaces are predominantly orientated in the circumferential direction, or in any case inclined at an angle of not more than 45° to the said circumferential direction; the said transverse surfaces also run transversely to the direction of movement, or in any case are inclined at an angle preferably within the range from 90° to 45° with respect to the equatorial plane.

The lateral surfaces delimiting the notch, extending from the base to the vertex, can be formed in various ways.

To facilitate the understanding of this matter, a block 33 comprising 3 types of notch, indicated by 34, 47 and 48 respectively, is shown in FIG. 5.

The notch 34 is delimited by a base 35 parallel to the transverse surface 27 and by two lateral surfaces 36 and 37, being the first and second surfaces respectively, formed along planes which are perpendicular to each other.

The first surface 36 is perpendicular to the top surface 28 and forms an angle α with the longitudinal surface 24 of the block.

The second surface 37 is inclined at an angle of β to a plane parallel to the top surface 28.

Preferably, the angle α is in the range from −30° to 30°; preferably, the angle β is in the range from −30° to 30°.

In a different example of embodiment from that which has been described, the surface 36 can be orientated parallel to the lateral surface 24.

The notches 29 and 30 can be formed with delimiting surfaces in the same way as that illustrated by way of example for the notch 34 of FIG. 5, or with variations of this forming process, for example with a first and a second surface 36 and 37 inclined at angles other than 90° to each other, as for example in the notch 48 of the said figure, or with the first and second surfaces having a configuration other than a flat one, and in particular forming a single curved surface such as that of the notch 47 in FIG. 5.

With reference now to the performance of the tyre described and illustrated in FIGS. 1 to 3, the favourable behaviour of this tyre on snow-covered ground will be demonstrated.

When the tyre is travelling in the rolling direction F, each longitudinal notch 29 initially meets the ground with its vertex in the optimal position to enable snow to efficiently enter and be compacted in the empty space between the vertex and the base 31.

This filling with snow and its compacting in the longitudinal notches 29 and 30 present in the blocks of the tread pattern gives rise to a plurality of areas distributed both circumferentially and transversely, which behave as elements for retaining the snow which has penetrated into the grooves between the blocks of the pattern, these elements impeding the discharge of the snow from the aforesaid pattern and thus advantageously maximizing the friction of the tyre on the snow-covered ground.

This advantageous result is achieved in all conditions of travel of the tyre, in other words in straight running and in cornering, and in acceleration as well as in braking, both for tyres fitted on the driving axle and for those fitted on the idle axle.

In order to increase the traction on snow-covered ground, the tyre comprises, in a variant embodiment, a tread with the pattern shown in FIG. 6.

This tyre is illustrated here with a tread identical to that of FIG. 2, except for the characteristic that each block in all the rows comprises two longitudinal notches 29 and 30 identical to those described above, but both tapered in the direction of rolling F.

The variant shown in FIG. 7 differs from those of FIGS. 2 and 6 in that each block in all the rows comprises a pair of longitudinal notches 29 and 30 tapered in the opposite direction to the direction of rolling F.

The tread has been described up to this point with reference to longitudinal notches 29 and 30 which are identical to each other in all the embodiments of FIGS. 2, 6 and 7.

In an alternative variant embodiment, the tread essentially has the same characteristics, except that it comprises one or more rows of blocks 40 (FIG. 8), each comprising a pair of longitudinal notches 41 and 42, tapered in opposite directions to each other, but with bases 43 and 44 opening on to the transverse grooves 16.

Alternatively, some embodiments of blocks according to the invention have longitudinal notches formed at a depth intermediate between the top surface and the base surface of the block.

Finally, in another variant embodiment shown in FIG. 4, the blocks of the tyre according to the invention have longitudinal notches (60) or transverse notches having their sides open only on the said top surfaces, the said notches being located preferably along the mid-lines of these surfaces.

In some embodiments, therefore, the tread shown in FIGS. 2, 6 and 7 can comprise one or more rows of blocks, each comprising, in combination or alternatively, longitudinal notches 29 and 30, further longitudinal notches 45, 46 and 60, as shown in FIG. 4, longitudinal notches similar to those indicated by the references 47 and 48 in FIG. 5, and also one or more longitudinal notches 48′ as shown in FIG. 8.

In particular, FIG. 4 shows some embodiments comprising a longitudinal notch 46 with a semicircular base and a curved lateral wall, while the longitudinal notch 45 has two flat delimiting surfaces along its extension, forming an acute angle between them.

Advantageously, these notches 45, 46, 47, 48 and 48′ associate their action with that of the notches 29 and 30, in that they maximize the quantity of fresh snow which can be captured by the grooves which these notches face.

The result of the present of the notches 45, 46, 47, 48 and 48′ is to facilitate a considerable compression of the snow between the walls of the blocks, causing the snow to become trapped.

In practice, the incorporation of the snow in the appropriate spaces of the tread is stably maintained, thus maximizing the snow-on-snow friction.

In the most general form, the tyre according to the invention can comprise transverse notches formed in each block, for example by removing elastomeric material between the top surface and the transverse surface forming one of the delimiting walls of a transverse groove.

The configuration of the transverse notches in the preferred shape is identical to that described with respect to the longitudinal notches 29 and 30 of FIG. 3, except for the fact that the transverse notches are made along transverse surfaces of the block.

By way of example, FIG. 9 shows a block 49 comprising two transverse notches 50 and 51, the first located between the top surface 28 and the transverse surface 26, and the second located between the top surface 28 and the transverse surface 27.

In the preferred shape of the transverse notches 50 and 51, the bases are closed in the same way as that of the longitudinal notch 34 shown in FIG. 5, instead of being open outwards, as shown in the variant of FIG. 9.

The transverse notches 50 and 51 have a function similar to that of the longitudinal notches, except in that they carry out their action of collecting and incorporating snow especially when the tyre is travelling round corners or under the action of slip forces.

It is also possible, in the case of transverse notches, to use transverse notches formed at a distance from the top surface of the block, as described above, for example as indicated for the transverse notch 52 of the block of FIG. 8.

It should be noted that the block forming part of the tyre according to the invention can comprise either longitudinal notches only, or transverse notches only, or both types of notch.

Advantageously, a large number of notches corresponds to a greater degree of deformability of the block, with consequently greater comfort during the travel of the tyre on dry roads, although a greater degree of deformability, by comparison with a block not having these notches, can cause a deterioration of behaviour on dry ground, particularly in terms of wear resistance.

In order not to compromise this performance, the applicant has found that, in the tyre according to the invention, the ratio between solid areas and voids in each block should preferably be in the range from 0.007 to 0.07.

It should also be noted that the presence of particularly long notches on top of the block tends to impart to the block, and therefore to the tread as a whole, a greater resistance, when travelling on snow-covered ground, to tangential stresses, particularly those present in cornering, in the axial direction of the tyre.

This favourable situation appears to depend on the formation of a step below the top surface of the block: it has been found that this step also improves the behaviour of the tyre on dry roads, in cornering and in braking, since it forms two edges (in place of a single edge as in blocks without notches) which act jointly to withstand the tangential, axial and circumferential forces applied to the block.

The result is unexpected, since the search for means of improving the grip on snow did not yield any indication that advantages would also be achieved in the running of the tyre on dry roads.

Awareness of the achievement of both an improvement on snow-covered ground and improvements in terms of the resistance of the block to tangential stresses on dry roads resulted from the observation of the behaviour of the tyre according to the invention, by comparison with a tyre with blocks not having notches, during cornering.

More particularly, a better knowledge of the favourable obtained results was pointed out from the observation during cornering of a tyre according to the invention comprising a footprint area very narrow in the travelling direction in respect of a tyre having the same footprint area but blocks without notches.

To enable the situation to be understood more clearly, it may be mentioned that, as persons skilled in the art will know, a tyre inflated to a given pressure specified by the manufacturer is deformed in contact with the ground in a footprint area characterized by a particular ratio between the length measured in the direction of the equatorial plane and the width measured in the axial direction.

There are known tyres on the market having footprint areas in which the said ratio is greater than 1, for example tyres of the 175/70R13 and 175/65R14 grades, as well as tyres having footprints with a ratio of less than 1, for example tyres of the 225/40R18 and 265/35R18 grades.

A tyre with a footprint area having a ratio of less than 1 tends to have less cornering stability than a tyre with a footprint area having a ratio of more than 1.

Given the above, it was found that tyres having a footprint area greater than 1 provided with longitudinal notches on the tops of the blocks have greater cornering stability than those having the same design and footprint area but having blocks without notches.

In respect of tyres with a footprint area of less than 1, FIG. 10 shows the mid-line profile 53 of a low-profile tyre of the 265/35R18 grade, provided with the tread pattern according to the invention with improved cornering stability.

The low-profile tyre shown in FIG. 10 shows particularly advantageous results in gripping on snow both in traction and in braking when it is provided with the longitudinal notches on the tops of the blocks as shown in FIGS. 2 and 3.

The invention has been described with reference to certain examples of embodiment, but the illustrated solutions are equally applicable to tyres with any number of circumferential rows of blocks., regardless of whether the said rows of blocks are delimited by straight rather than zigzag grooves or whether the blocks comprise sipes, either straight or zigzag, and also to tyres for any kind of vehicle and operation, since the provision made according to the invention for running on snow does not adversely affect running on dry roads.

Furthermore, the longitudinal notches of the blocks of one row could be staggered circumferentially with respect to those of the adjacent row by an amount different from that shown in FIGS. 2, 6 and 7, for example in order to improve the quietness of running.

1-20. (canceled)

21. A tyre, comprising:
a tread;
wherein the tread comprises a relief pattern,
wherein the relief pattern is delimited by a plurality of circumferential and transverse grooves forming at least one circumferential row of blocks,
wherein the at least one row of blocks projects from a base surface of the tread,
wherein the at least one row of blocks extends radially outward as far as top surfaces of the blocks,
wherein each block is delimited by longitudinal and transverse lateral surfaces,
wherein each of the lateral surfaces is part of at least one wall of the grooves,
wherein at least one block comprises at least one notch in one or more surfaces of the at least one block,
wherein at least one side of the at least one notch is open along an entire length of one of the surfaces,
wherein the at least one notch comprises a greater dimension oriented in a direction of one of the circumferential and transverse grooves, and
wherein the at least one notch is tapered along the greater dimension between a base and a vertex opposite the base.

22. The tyre of claim 21, wherein each of the longitudinal lateral surfaces is part of at least one wall of the circumferential grooves.

23. The tyre of claim 21, wherein each of the transverse lateral surfaces is part of at least one wall of the transverse grooves.

24. The tyre of claim 21, wherein each of the longitudinal lateral surfaces is part of at least one wall of the circumferential grooves, and
wherein each of the transverse lateral surfaces is part of at least one wall of the transverse grooves.

25. The tyre of claim 21, wherein the at least one notch is formed along a delimiting edge between the top surface of the at least one block and a respective wall of the grooves.

26. The tyre of claim 21, wherein each of the blocks of at least one row comprises at least one notch.

27. The tyre of claim 21, wherein the base of the at least one notch is generated by a plane intersecting the at least one block at a predetermined distance from the vertex.

28. The tyre of claim 21, wherein two or more of the notches present in a same surface of the at least one block are tapered in a same direction.

29. The tyre of claim 28, wherein the taper direction is opposite to a rolling direction of the tyre.

30. The tyre of claim 21, wherein at least two of the notches present in a same surface of the at least one block are tapered in opposite directions.

31. The tyre of claim 21, wherein each block of the at least one row comprises at least one first and second longitudinal notch,
wherein the first longitudinal notch is on a delimiting edge between the top surface and a first longitudinal lateral surface, and
wherein the second longitudinal notch is on a delimiting edge between the top surface and a second longitudinal lateral surface.

32. The tyre of claim 31, wherein the first and second longitudinal notches comprise tapers running in directions opposite to each other.

33. The tyre of claim 21, wherein the at least one block comprises at least one notch running transversely with respect to a rolling direction of the tyre.

34. The tyre of claim 33, wherein the at least one transverse notch is formed along a delimiting edge between the top surface and one of two transverse lateral surfaces of the at least one block.

35. The tyre of claim 21, wherein each block comprises a pair of notches that are transverse with respect to a rolling direction of the tyre.

36. The tyre of claim 21, wherein the at least one block comprises one or more longitudinal notches.

37. The tyre of claim 21, wherein the at least one notch comprises a pyramidal shape,
wherein the pyramidal shape is essentially delimited by the base, a first plane, and a second plane, and
wherein the first and second planes intersect each other.

38. The tyre of claim 37, wherein the first plane is perpendicular to a top surface of the at least one block,
wherein the first plane is inclined at a first angle to a wall of a groove in which the at least one notch is formed, and
wherein the second plane is inclined at a second angle to a plane parallel to the top surface.

39. The tyre of claim 38, wherein the first angle is in a range from −30° to 30°.

40. The tyre of claim 38, wherein the second angle is in a range from −30° to 30°.

41. The tyre of claim 21, wherein the at least one notch extends over a length at least equal to 65% of a length of an edge formed by an intersection between a lateral surface of the at least one block in which the at least one notch is formed and the top surface of the at least one block.

42. The tyre of claim 21, wherein a ratio of a maximum depth of the at least one notch to a maximum longitudinal extension of the at least one notch is greater than 0.06:1 and less than 0.6:1,
wherein the maximum depth of the at least one notch is measured in a direction perpendicular to the top surface of the at least one block, and
wherein the maximum longitudinal extension of the at least one notch is measured along a corresponding edge on the top surface of the at least one block.

43. A method for increasing traction of a tyre, comprising:
providing the tyre with a tread;
wherein the tread comprises a relief pattern,
wherein the relief pattern is delimited by a plurality of circumferential and transverse grooves forming at least one circumferential row of blocks,
wherein the at least one row of blocks projects from a base surface of the tread,
wherein the at least one row of blocks extends radially outward as far as top surfaces of the blocks,
wherein each block is delimited by longitudinal and transverse lateral surfaces,
wherein each of the lateral surfaces is part of at least one wall of the grooves,
wherein at least one notch is formed in one or more surfaces of the blocks,
wherein at least one side of the at least one notch is open along an entire length of one of the surfaces,
wherein the at least one notch comprises a greater dimension oriented in a direction of one of the circumferential and transverse grooves, and
wherein the at least one notch is tapered along the greater dimension between a base and a vertex opposite the base.
